(19) United States
(12) Patent Application Publication
(10) Pub. No.: US 2021/0042295 A1
(43) Pub. Date: Feb. 11, 2021

(54) BLOCKCHAIN-BASED DATA MANAGEMENT METHOD AND RELATED SYSTEM

(71) Applicant: SIMPLECREDIT MICRO-LENDING CO., LTD., Chongqing (CN)

(72) Inventor: Kaining Wang, Chongqing (CN)

(21) Appl. No.: 16/978,182

(22) PCT Filed: Apr. 25, 2018
(86) PCT No.: PCT/CN2018/084465

§ 371 Date: Sep. 3, 2020

(51) Int. Cl. G06F 16/23

(52) U.S. Cl. CPC G06F 16/2379

(57) ABSTRACT

A blockchain-based data management method and a related system are provided. The method comprises: receiving, by a blockchain system, a first changed data transmitted by a centralized system, updating the first changed data to all nodes included in the blockchain system, detecting whether an account information associated with the first changed data exists, and sending a prompt information to a target account corresponding to the account information if the blockchain system detects that the account information associated with the first changed data exists. Blockchain-based and smart contract-combined distributed management of data can be realized without making a relatively large adjustment on a traditional data system, and the privilege of centralized management of the traditional data system is also retained. When the data is changed, the blockchain target account corresponding to the changed data can be informed, so that a data changed message is timely and effectively delivered.

### FIELD OF THE INVENTION

The present invention relates to the technical field of data processing, and more particularly relates to a blockchain-based data management method and a related system.

### BACKGROUND OF THE INVENTION

At present, traditional data systems (such as data systems in the financial field) are generally centralized systems. For this kind of data systems, in order to ensure the security of data, usually only personnel with management authority can manage the data systems, and at the same time, only internal personnel can view system data. When data of this kind of data system is changed, a client or consumer is unaware of the situation, so this kind of data system is prone to data tampering, which affects the authenticity of the data. Therefore, how to ensure the authenticity of data while ensuring the data security has become an urgent problem to be solved.

### SUMMARY OF INVENTION

The present invention provides a blockchain-based data management method and a related system. On one hand, blockchain-based and smart contract-combined distributed management of data can be realized without making a relatively large adjustment on a traditional data system; and on the other hand, when the data is changed, a target account corresponding to the changed data can also be informed, so that a data updated message is timely and effectively delivered.

According to a first aspect, the present invention provides a blockchain-based data management method, which is applied to an information processing system. The information processing system comprises a centralized system and a blockchain system. The blockchain system comprises at least one node, and the method comprises:

receiving, by the blockchain system, a first changed data transmitted by the centralized system, and updating the first changed data to all nodes included in the blockchain system;

detecting, by the blockchain system, whether an account information associated with the first changed data exists; and

sending, by the blockchain system, prompt information to a target account corresponding to the account information if the blockchain system detects that the account information associated with the first changed data exists, wherein the prompt information is used for prompting that data corresponding to the target account has been changed.

Optionally, the blockchain system can further receive a data change request coming from a first account and carrying a second changed data, wherein the data change request is used for requesting to change data corresponding to the first account according to the second changed data, and the first account is any one of at least one blockchain account; detect the data type of the second changed data; determine a target information processing strategy corresponding to the data type according to a smart contract; and execute the target information processing strategy on the data change request.

Optionally, the smart contract comprises a change condition for changing the data corresponding to the first account. A specific implementation mode for executing the target information processing strategy is: transmitting, by the blockchain system, the data change request to associated accounts, wherein the associated accounts comprise at least one of the following: an account associated with the second changed data and an account associated with the first account; acquiring a feedback information of the associated accounts for the data change request; and changing the data corresponding to the first account according to the second changed data if the feedback information meets the change condition.

Optionally, a specific implementation mode for executing the target information processing strategy is: transmitting, by the blockchain system, the data change request to the centralized system, wherein the data change request is used for instructing the centralized system to send response information about successful verification after the centralized system successfully verifies the data change request; and receiving, by the blockchain system, the response information, and changing the data corresponding to the first account according to the second changed data.

Optionally, the blockchain system can further establish a correspondence between the predefined data types and the information processing strategies, and generate the smart contract according to the correspondence.

Optionally, a specific implementation mode of detecting, by the blockchain system, whether an account information associated with the first changed data exists is: determining, by the blockchain system, the data type of the first changed data, and detecting whether the data type is bound with an account information; or, determining whether an account information exists in the first changed data.

Optionally, after acquiring the feedback information of the associated accounts for the data change request, the blockchain system can further parse the feedback information, so as to determine the number of accounts allowing the data change request in the associated accounts, and determine that the feedback information meets the change condition if the number of accounts is greater than or equal to a preset number threshold value.

According to a second aspect, the present invention provide a blockchain-based data management apparatus, which is applied to an information processing system. The information processing system comprises a centralized system and a blockchain system. The apparatus comprises:

a receiving and transmitting module, used for receiving a first changed data transmitted by the centralized system, and updating the first changed data to all nodes included in the blockchain system; and

a detection module, used for detecting whether an account information associated with the first changed data exists;

wherein the receiving and transmitting module is further used for sending prompt information to a target account corresponding to the account information if the detection module detects that account information associated with the first changed data exists, wherein the prompt information is used for prompting that data corresponding to the target account has been changed.

According to a third aspect, the embodiments of the present invention provide a blockchain system. The blockchain system comprises a processing apparatus and a storage apparatus. The processing apparatus and the storage apparatus are connected with each other. The storage apparatus is used for storing a computer program. The computer program comprises a program instruction. The processing apparatus is configured to call the program instruction to implement the method of the first aspect.

According to a fourth aspect, the present invention provides a computer-readable storage medium. The computer-readable storage medium stores a computer program. The computer program comprises a program instruction. The program instruction, when executed by a processor, causes the processor to implement the method of the first aspect.

According to a fifth aspect, the present invention provides an information processing system. The information processing system comprises: a centralized system and a blockchain system, wherein

the centralized system is used for transmitting a first changed data to the blockchain system;

the blockchain system is used for receiving the first changed data transmitted by the centralized system, and updating the first changed data to all nodes included in the blockchain system. When detecting that account information associated with the first changed data exists, the blockchain system sends prompt information to a target account corresponding to the account information, and the prompt information is used for prompting that data corresponding to the target account has been changed.

In an embodiment of the present invention, the blockchain system can receive the first changed data transmitted by the centralized system, update the first changed data to all nodes included in the blockchain system, detect whether account information associated with the first changed data exists, and send the prompt information to the target account corresponding to the account information if the blockchain system detects that account information associated with the first changed data exists. In the present invention, on one hand, blockchain-based distributed management of data can be realized without making a relatively large adjustment on a traditional data system, and on the other hand, the privilege of centralized management of the traditional data system is also retained, thereby better meeting an actual need of the industry. Furthermore, when the data is changed, the target account corresponding to the changed data can further be informed, so that a data changed message is timely and effectively delivered.

### BRIEF DESCRIPTION OF THE DRAWINGS

In order to describe embodiments of the present invention or technical solutions in the existing art more clearly, drawings required to be used in the embodiments will be briefly introduced below. It is apparent that the drawings in the descriptions below are only some embodiments of the present invention. Those of ordinary skill in the art can also obtain other drawings according to these drawings without making creative work.

FIG. 1 is a structural schematic diagram of an information processing system provided by an embodiment of the present invention;

FIG. 2 is a flow diagram of a blockchain-based data management method provided by an embodiment of the present invention;

FIG. 3 is a flow diagram of another blockchain-based data management method provided by an embodiment of the present invention;

FIG. 4 is a schematic block diagram of a blockchain-based data management apparatus provided by an embodiment of the present invention; and

FIG. 5 is a structural schematic diagram of a blockchain system provided by an embodiment of the present invention.

### DETAILED DESCRIPTION OF ILLUSTRATED EMBODIMENTS

The technical solutions in the embodiments of the present invention will be described clearly and completely below in combination with the accompanying drawings in the embodiments of the present invention. Apparently, the embodiments described are only a part of embodiments of the present invention, not all the embodiments. Based on the embodiments in the present invention, all other embodiments obtained by those of ordinary skill in the art without doing creative work shall fall within the protection scope of the present invention.

A blockchain technology is an Internet database technology, and its essence is a method of decentration and data storage, transmission and certification in a distributed structure. A blockchain system is based on the blockchain technology, and uses data blocks to replace the current dependence of the Internet on a central server, so that all data changes or transaction items are recorded on one cloud system, and self-verification of data in data transmission is realized. Once information is verified successfully and added to the blockchain system, it will be permanently stored, and data registered on the blockchain system cannot be tampered. A smart contract deployed on the blockchain system is a digital contract that can execute a contract code on a Central Processing Unit (CPU). When the terms of the smart contract are met, predefined rules and terms can be automatically executed.

At present, a traditional data system is generally a centralized system. When data of this kind of system is changed, a client or customer is unaware of the situation, so this kind of data system is prone to data tampering, which makes the authenticity not be guaranteed. Based on this demand, the blockchain technology emerges, but for enterprises that already have the traditional data systems or need centralized management, if only the blockchain technology is applied, the actual needs of the enterprises cannot be met. The centralized system can be a banking system, a loan system, a financial system such as securities or insurance, or can be the headquarters system of any company, and the like.

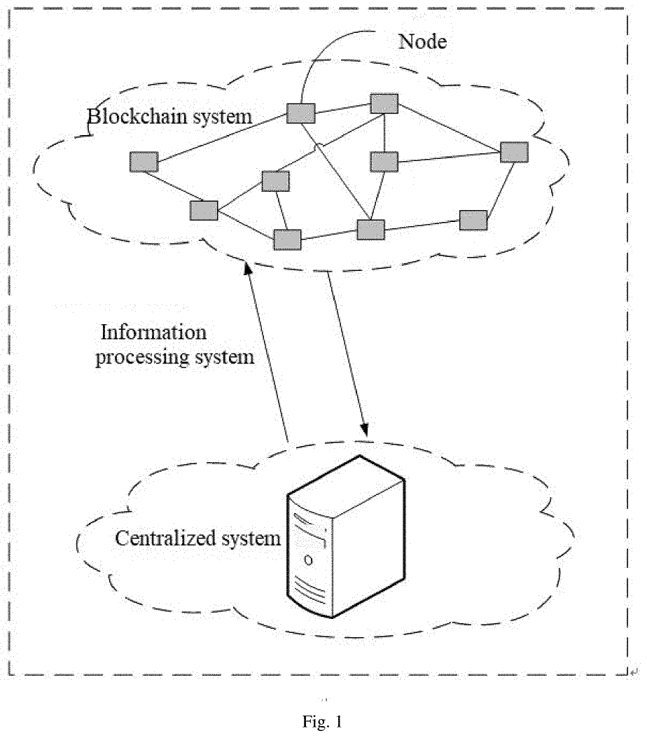

In order to solve the above problems, referring to FIG. 1, the embodiment of the present invention provides an information processing system. The information processing system comprises a centralized system and a blockchain system, and can be applied to the fields of loans, securities, insurance, finance, etc. The blockchain system is a distributed management system, and the distributed management system comprises at least one node. In the embodiment of the present invention, one node can correspond to one node device, or a plurality of nodes can correspond to one node device. The node device can be a terminal device, which can include but is not limited to: a Personal Computer (PC), a tablet computer (PAD), a mobile phone, a smart phone, a notebook computer, etc.; and it can also be a server.

In one embodiment, the centralized system can transmit changed data (i.e., a first changed data) to the blockchain system. Further, the blockchain system can detect whether account information associated with the first changed data exists after receiving the first changed data from the centralized system, and if the account information exists, the blockchain system sends prompt information to a target account corresponding to the account information to prompt that data corresponding to the target account have been changed. The embodiment of the present invention establishes this information processing system combining the blockchain system and the centralized system, on one hand, blockchain-based distributed management of data can be realized without making a relatively large adjustment on a traditional data system, and on the other hand, the privilege of centralized management of the traditional data system is also retained, thereby better meeting an actual need of the industry. Furthermore, when the data is changed, the target account corresponding to the changed data can further be informed, so that a data changed message is timely and effectively delivered.

It should be noted that the first changed data and second changed data described in the present invention can refer to any data, and they can be the same or different. For different application scenarios, the first changed data and the second changed data can refer to different data. For example, when an application scenario is a loan system, the first changed data can be sales data of a certain enterprise, and the second changed data can be a loan amount, etc. of the enterprise. For another example, when the application scenario is an insurance system, the first changed data can be the amount of insurance of John Doe in a certain year, and the second changed data can be the number of insurance claims of John Doe in this year, etc. The present invention does not specifically limit this.

The account information associated with the first changed data described in the present invention can comprise at least one of the following: an account information corresponding to the data type of the first changed data and an account information included in the first changed data. The account information can be preset, such as an enterprise account, a user ID, and the like. The target account described in the present invention is a blockchain account (hereinafter referred to as a blockchain target account) corresponding to the above-mentioned account information on the blockchain system.

The change of data described in the present invention comprises at least one of adding, modification and deletion of data, which is not specifically limited in the present invention.

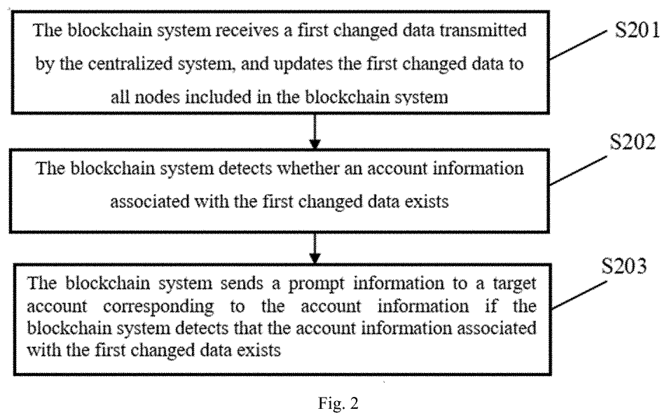

Moreover, referring to FIG. 2, FIG. 2 is a flow diagram of a blockchain-based data management method provided by the embodiment of the present invention. The method is applied to an information processing system, and the information processing system comprises a centralized system and a blockchain system. As shown in the figure, the data management method can comprise the following steps.

S201: the blockchain system receives first changed data transmitted by the centralized system, and updates the first changed data to all nodes included in the blockchain system.

In one embodiment, when the centralized system detects data change, it can transmit the changed data (i.e., the first changed data) to the blockchain system through the first node that has been connected. Further, the blockchain system can update the first changed data to all nodes in the blockchain system after receiving the first changed data, thereby realizing distributed management of the data.

In one embodiment, the blockchain system can update the first changed data to all nodes in the blockchain system after receiving the first changed data, finds target data corresponding to the first changed data from storage apparatuses corresponding to all nodes respectively, and changes the target data to the first changed data, thus achieving the objective of updating the first changed data to all nodes in the blockchain system and realizing the distributed management of the data. Both the first changed data and the target data are correlated or correspond to each other. For example, the first changed data is a repayment amount of enterprise A of March, so the target data is also a repayment amount of enterprise A of March.

Exemplarily, if the first changed data transmitted by the centralized system is a car insurance payment amount of John Doe in the year of 2018, which is specifically 3500 RMB, the blockchain system can transmit the first changed data to all nodes of the blockchain system after receiving the first changed data transmitted by the centralized system, finds the data corresponding to the car insurance payment amount of John Doe in the year of 2018 from the storage apparatuses corresponding to all nodes respectively, and changes the car insurance payment amount of John Doe in the year of 2018 to 3500 RMB.

S202: the blockchain system detects whether account information associated with the first changed data exists. The account information associated with the first changed data can comprise at least one of the following: account information corresponding to the data type of the first changed data and account information included in the first changed data. The account information can be preset, such as an enterprise account, a user ID, and the like.

In one embodiment, the blockchain system can pre-bind different types of data with corresponding account information, as shown in Table 1-1. In this case, the blockchain system can determine the data type of the first changed data after receiving the first changed data from the centralized system, and then detect whether the data type is bound with account information. If the data type of the first changed data is bound with account information, it is regarded that account information associated with the first changed data exists. On the contrary, if the data type of the first changed data is not bound with account information, it is regarded that account information associated with the first changed data does not exist. Exemplarily, a binding relationship between the data type and the account information can be as shown in Table 1-1. If the blockchain system determines that the data type of the first changed data is Type-1, it can be detected according to the preset binding relationship that the account information bound with Type-1 is M-01, that is, it can be determined that the data type of the first changed data is bound with account information. Or, if the blockchain system determines that the data type of the first changed data is Type-3, the account information bound with Type-3 cannot be detected according to the preset binding relationship, that is, it can be determined that the data type of the first changed data is not bound with account information.

TABLE 1-1

| Data type | Account information |
|---|---|
| Type-1 | M-01 |
| Type-2 | M-02 |

In one embodiment, the blockchain system can determine whether account information exists in the first changed data after receiving the first changed data from the centralized system. Further, if the blockchain system identifies account information in the first changed data, it can be determined that the account information associated with the first changed data exists. If the blockchain system does not identify account information in the first changed data, it can be determined that account information associated with the first changed data does not exist.

S203: the blockchain system sends prompt information to a target account corresponding to the account information if the blockchain system detects that account information associated with the first changed data exists. The prompt information is used for prompting that the data corresponding to the target account have been changed.

In one embodiment, the blockchain system can identify the target account from the account information if the blockchain system detects that account information associated with the first changed data exists, and send the prompt information to the target account to prompt that the data corresponding to the target account have been changed, that is, when data is changed, the target account corresponding to the changed data can be informed, which is favorable for guaranteeing the security of data and guaranteeing the authenticity of data. In one embodiment, the prompt information can prompt that the data corresponding to the target account have been changed, and can also prompt that the data corresponding to the first changed data of the target account have been changed. For example, if the first changed data is a sales amount of enterprise A, which is specifically 10,000 RMB, the prompt information can be “the sales amount of enterprise A has been changed to 10,000 RMB”.

In one embodiment, the blockchain system can further acquire a contact way associated with the target account, and then send the prompt information to the target account through the contact way. The contact way can be, for example, short message, e-mail, and chat message. Exemplarily, if the first changed data is sales data of enterprise A of April, the target account identified by the blockchain system from the account information associated with the first changed data comprises: number-01 and number-02. In this case, the blockchain system can send the prompt information to the target accounts number-01 and number-02 to prompt the target accounts that the sales data of enterprise A of April have been changed.

In the embodiments of the present invention, the blockchain system can receive the first changed data transmitted by the centralized system, update the first changed data to all nodes included in the blockchain system, detect whether account information associated with the first changed data exists, and send the prompt information to the target account corresponding to the account information if the blockchain system detects that account information associated with the first changed data exists. By the adoption of the present invention, on one hand, blockchain-based distributed management of data can be realized without making a relatively large adjustment on a traditional data system; and on the other hand, when data is changed, a blockchain target account corresponding to the changed data can also be informed, so that a data changed message is timely and effectively delivered.

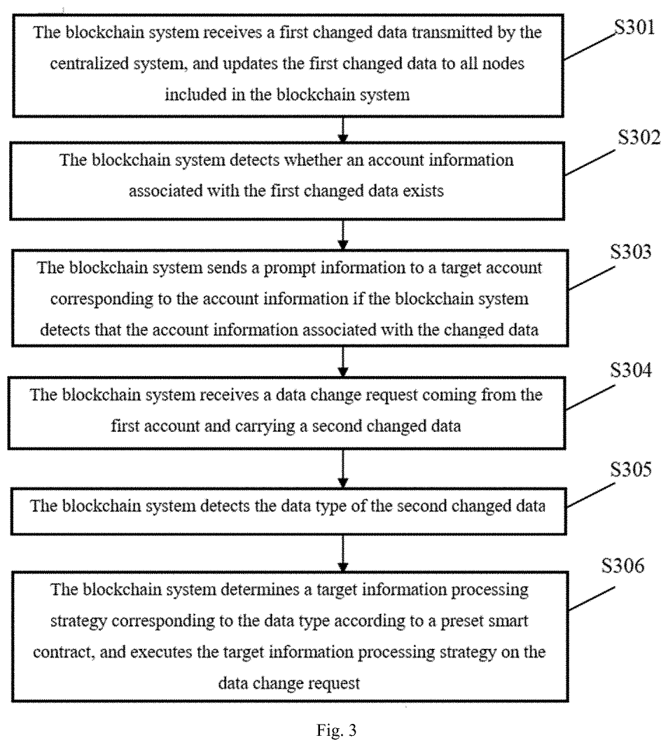

Moreover, referring to FIG. 3, FIG. 3 is a flow diagram of a blockchain-based data management method provided by the embodiment of the present invention. The method is applied to an information processing system, and the information processing system comprises a centralized system and a blockchain system. As shown in the figure, the data management method can comprise the following steps.

S301: the blockchain system receives first changed data transmitted by the centralized system, and updates the first changed data to all nodes included in the blockchain system.

S302: the blockchain system detects whether account information associated with the first changed data exists.

S303: the blockchain system sends prompt information to a target account corresponding to the account information if the blockchain system detects that account information associated with the changed data exists.

Specific implementation modes of S301 to S303 can refer to related descriptions of S201 to S203 in the above embodiment, and the present invention will not make repeated descriptions here.

S304: the blockchain system receives a data change request coming from a first account and carrying second changed data, wherein the data change request is used for requesting to change data corresponding to the first account according to the second changed data. The first account is any one of at least one blockchain account.

In one embodiment, when the first account needs to change any data, the first account can be connected with any node in the blockchain system, and the data change request is issued to the blockchain system via the node, and the data change request carries changed data (i.e., the second changed data) for any data. In this case, the blockchain system can acquire the second changed data from the data change request after receiving the data change request.

S305: the blockchain system detects the data type of the second changed data.

S306: the blockchain system determines a target information processing strategy corresponding to the data type according to a preset smart contract, and executes the target information processing strategy on the data change request.

In one embodiment, the blockchain system can establish a correspondence between predefined data types and information processing strategies in advance, and generate the smart contract according to the correspondence. In this case, the blockchain system can determine the target information processing strategy corresponding to the data type in the correspondence indicated in the smart contract after detecting the data type of the second changed data, and then execute the target information processing strategy on the data change request. By the adoption of the present invention, different target information processing strategies can be executed on the data types of the changed data, which is favorable for improving the processing efficiency of data change. The correspondence indicated in the preset smart contract can be as shown in Table 2-1.

TABLE 2-1

| Data type | Information processing strategy |
|---|---|
| Type-1 | Stra-01 |
| Type-2 | Stra-02 |

Exemplarily, the correspondence indicated in the preset smart contract is as shown in Table 2-1. After acquiring the second changed data, the blockchain system detects that the data type of the second changed data is Type-1, so it can be determined according to the smart contract that the target information processing strategy corresponding to the data type Type-1 is Stra-01, and then the target information processing strategy Stra-01 is executed.

It should be noted that for different application scenarios, the centralized system, the blockchain system, the data type of the second changed data and the information processing strategy described in the present invention can be different. Exemplarily, when the application scenario is a loan system, the centralized system described in the present invention can be a loan platform, the blockchain system can be a blockchain system applied to loans, and the data type of the second changed data can comprise enterprise sales data, an enterprise loan amount and the like. Further, the target information processing strategy corresponding to the enterprise sales data can be that the blockchain system transmits the second changed data to an enterprise (hereinafter referred to as the relevant enterprise) associated with the second changed data, and the relevant enterprise decides whether to agree to change the data. Or, the target information processing strategy corresponding to the enterprise loan amount can be that the blockchain system transmits the second changed data to the loan platform, and the loan platform decides whether to agree to change the data.

The blockchain system can predefine various data types, and different data types respectively correspond to different target information processing strategies. Exemplarily, the present invention can comprise at least one target information processing strategy, which can specifically comprise a first target information processing strategy, a second target information processing strategy and the like.

In one embodiment, the preset smart contract can comprise a change condition for changing the data corresponding to the first account. In this case, the target information processing strategy executed by the blockchain system on the data change request can be transmitting the data change request to associated accounts, acquiring feedback information of the associated accounts for the data change request, and changing the data corresponding to the first account according to the second changed data if the feedback information meets the change condition.

The associated accounts comprise at least one of the following: an account associated with the second changed data and an account associated with the first account. Specifically, the account associated with the second changed data can be an account having a binding relationship with the second changed data in advance, and can also be an account extracted from the second changed data, that is, the second changed data includes this account. The account associated with the first account can be an account having a binding relationship with the first account in advance. In the embodiment of the present invention, the associated accounts may include the account of the centralized system, or may not include the account of the centralized system. This solution does not specifically limit this.

In one embodiment, the feedback information can comprise the number of accounts allowing the data change request in the associated accounts. In one embodiment, after acquiring the feedback information of the associated accounts for the data change request, the blockchain system can parse the feedback information, so as to determine the number of accounts allowing the data change request in the associated accounts, and determine that the feedback information meets the change condition if the number of accounts is greater than or equal to a preset number threshold value.

In one embodiment, the feedback information can further comprise the percentage of accounts allowing the data change request in the associated accounts. In one embodiment, after acquiring the feedback information of the associated accounts for the data change request, the blockchain system can parse the feedback information, so as to determine the percentage of accounts allowing the data change request in the associated accounts, and determine that the feedback information meets the change condition if the percentage is greater than or equal to a preset percentage threshold value. For example, if the percentage threshold value is preset to be 95%, and the blockchain system parses the feedback information to determine that the percentage of the accounts allowing the data change request in the associated accounts is 96%, it can be determined that the feedback information meets the change condition.

Exemplarily, if the above method is applied to the insurance system, the blockchain system can be applied to the insurance system; the second changed data from the first account is a compensation amount of the accident insurance of John Doe, which is specifically 100,000 RMB; the change condition (i.e., the condition included in the smart contract) for changing the data corresponding to the first account is that the number of the accounts allowing the data change request is 5, and the associated accounts include number-01, number-02, number-03, number-04, number-05 and number-06. In this case, the blockchain system can transmit the data change request about the second changed data to number-01, number-02, number-03, number-04, number-05 and number-06, and the associated accounts may send instruction information whether to allow the data change request after receiving the data change request. The blockchain system counts these pieces of instruction information, and determines that the number of accounts allowing the data change request in the 6 associated accounts is 6 (i.e., the feedback information). It is determined that the number of the accounts allowing the data change request is more than 5, so that it can be determined that the feedback information meets the change condition, and then the compensation amount of the accident insurance of John Doe is changed to 100,000 RMB according to the second changed data.

In one embodiment, the target information processing strategy executed by the blockchain system on the data change request can also be that the blockchain system transmits the data change request to the centralized system, and the data change request is used for instructing the centralized system to send response information about successful verification after the centralized system successfully verifies the data change request. Further, the blockchain system can receive the response information, and change the data corresponding to the first account according to the second changed data after receiving the response information.

In one embodiment, the blockchain system can transmit the data change request coming from the first account and carrying the second changed data to the centralized system, and the centralized system can verify the data change request after receiving the data change request and send the response information about successful verification to the blockchain system if the centralized system successfully verifies the data change request, so as to cause the blockchain system to change the data corresponding to the first account according to the second changed data after receiving the response information.

For example, if the centralized platform is the loan platform, the second changed data carried in the data change request from the first account is a load amount of enterprise XYD, which is specifically 20,000 RMB. In this case, when a user of the first account intends to change the loan amount of enterprise XYD to 20,000 RMB, the user can transmit the data change request to the loan platform through the blockchain system, and the data change request carries the second changed data used for requesting to change the loan amount of enterprise XYD to 20,000 RMB. Further, the loan platform verifies the data change request after receiving the data change request. If the loan platform agrees to change the loan amount of enterprise XYD to 20,000 RMB, the loan platform determines that the verification of the data change request succeeds, and then the response information about successful verification is sent to the blockchain system. The blockchain system changes the loan amount of enterprise XYD to 20,000 RMB according to the second changed data.

In the embodiments of the present invention, the blockchain system can receive the first changed data transmitted by the centralized system, update the first changed data to all nodes included in the blockchain system, detect whether account information associated with the first changed data exists, and send the prompt information to the target account corresponding to the account information if it is detected that account information associated with the first changed data exists. Further, the blockchain system can further receive the data change request coming from the first account and carrying the second changed data, detect the data type of the second changed data, then determine the target information processing strategy corresponding to the data type according to the preset smart contract, and execute the target information processing strategy on the data change request. By the application of the present invention, on one hand, blockchain-based and smart contract-combined distributed management of data can be realized without making a relatively large adjustment on a traditional data system, and on the other hand, the privilege of centralized management of the traditional data system can also be retained, thereby better meeting an actual need of the industry. Furthermore, when the data is changed, the target account corresponding to the changed data can further be informed, so that a data updated message is timely and effectively delivered.

The embodiments of the present invention further provide a computer-readable storage medium. The computer-readable storage medium stores a program instruction. The program instruction, when executed, is used for implementing the corresponding method described in the above embodiments.

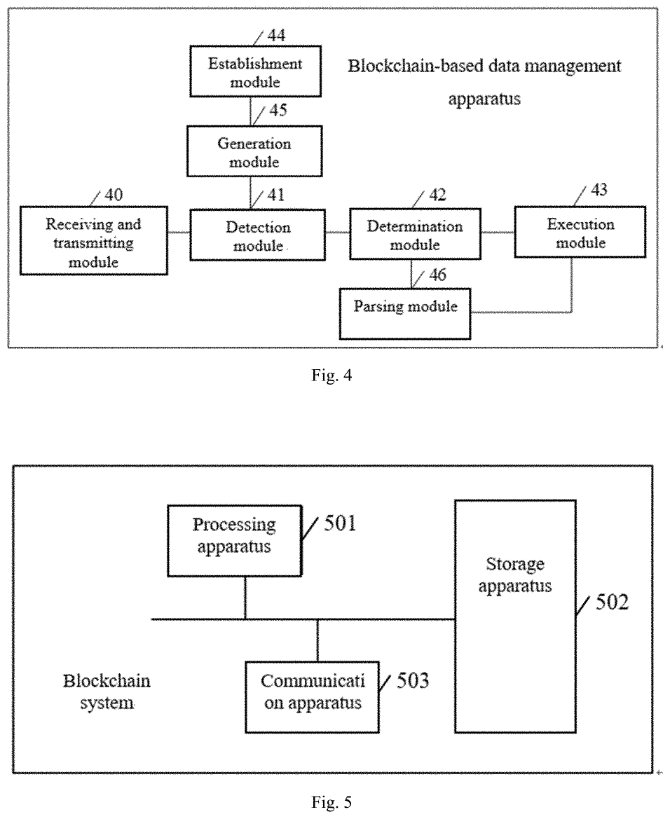

Moreover, referring to FIG. 4, FIG. 4 is a structural schematic diagram of a blockchain-based data management apparatus provided by the embodiment of the present invention. The apparatus comprises modules used for implementing the foregoing method as shown in FIG. 2 or FIG. 3. Specifically, the apparatus of the present embodiment comprises: a receiving and transmitting module 40 and a detection module 41.

The receiving and transmitting module 40 is used for receiving first changed data transmitted by a centralized system, and updating the first changed data to all nodes included in a blockchain system.

The detection module 41 is used for detecting whether account information associated with the first changed data exists.

The receiving and transmitting module 40 is further used for sending prompt information to a target account corresponding to the account information if the detection module detects that account information associated with the first changed data exists, wherein the prompt information is used for prompting that data corresponding to the target account have been changed.

Optionally, the apparatus further comprises: a determination module 42 and an execution module 43.

The receiving and transmitting module 40 is also used for receiving a data change request coming from a first account and carrying second changed data. The data change request is used for requesting to change data corresponding to the first account according to the second changed data, and the first account is any one of at least one blockchain account.

The detection module 41 is also used for detecting the data type of the second changed data.

The determination module 42 is used for determining a target information processing strategy corresponding to the data type according to a preset smart contract.

The execution module 43 is used for executing the target information processing strategy determined by the determination module 42 on the data change request.

Optionally, the smart contract comprises a change condition for changing data corresponding to the first account. The execution module 43 is specifically used for transmitting the data change request to associated accounts through the blockchain, wherein the associated accounts comprise at least one of the following: an account associated with the second changed data and an account associated with the first account; acquiring feedback information of the associated accounts for the data change request; and changing the data corresponding to the first account according to the second changed data if the feedback information meets the change condition.

Optionally, the execution module 43 is also specifically used for: transmitting the data change request to the centralized system, wherein the data change request is used for instructing the centralized system to send response information about successful verification after the centralized system successfully verifies the data change request; and receiving the response information, and changing the data corresponding to the first account according to the second changed data.

Optionally, the apparatus further comprises:

an establishment module 44, used for establishing a correspondence between predefined data types and information processing strategies; and

a generation module 45, used for generating the smart contract according to the correspondence.

Optionally, the detection module 41 is specifically used for determining the data type of the first changed data, and detecting whether the data type is bound with account information; or, determining whether account information exists in the first changed data.

Optionally, the apparatus further comprises: a parsing module 46.

The parsing module 46 is used for parsing the feedback information to trigger the determination module 42 to determine the number of accounts allowing the data change request in the associated accounts, and determining that the feedback information meets the change condition if the number of accounts is greater than or equal to a preset number threshold value.

It should be noted that the functions of the functional modules of the blockchain-based data management apparatus described by the embodiments of the present invention can be specifically realized according to the method in the method embodiment in FIG. 2 or FIG. 3, so that their specific implementation processes can refer to related descriptions of the method embodiment in FIG. 2 or FIG. 3.

In the embodiments of the present invention, the receiving and transmitting module 40 can receive the first changed data transmitted by the centralized system, and update the first changed data to all nodes included in the blockchain system, the detection module 41 can detect whether account information associated with the first changed data exists, and the receiving and transmitting module 40 sends the prompt information to the target account corresponding to the account information if the detection module 41 detects that account information associated with the first changed data exists. By the adoption of the present invention, on one hand, blockchain-based distributed management of data can be realized without making a relatively large adjustment on a traditional data system; and on the other hand, when data is changed, a blockchain target account corresponding to the changed data can also be informed, so that a data changed message is timely and effectively delivered.

Moreover, referring to FIG. 5, FIG. 5 is a structural schematic diagram of a blockchain system provided by the embodiment of the present invention. A data management device comprises a processing apparatus 501, a storage apparatus 502 and a communication apparatus 503. The processing apparatus 501, the storage apparatus 502 and the communication apparatus 503 can perform data interaction, and corresponding information processing functions are implemented by the processing apparatus 501.

The storage apparatus 502 can comprise a volatile memory, such as a random-access memory (RAM). The storage apparatus 502 can also comprise a non-volatile memory, such as a flash memory and a solid-state drive (SSD).The storage apparatus 502 can also comprise a combination of memories of the foregoing types.

The communication apparatus 503 can perform data interaction with other communication apparatuses in the blockchain system or the centralized system.

The processing apparatus 501 can be a central processing unit (CPU), and the processing apparatus 501 can also be a combination of the CPU and a GPU. The blockchain system can comprise a plurality of CPUs and GPUs as required for corresponding information processing. In one embodiment, the storage apparatus 502 is used for storing a program instruction. The processing apparatus 501 can call the program instruction to: receive, through the communication apparatus 503, first changed data transmitted by the centralized system, and update the first changed data to all nodes included in the blockchain system; detect whether account information associated with the first changed data exists; and send prompt information to a target account corresponding to the account information if account information associated with the first changed data exists. The prompt information is used for prompting that data corresponding to the target account have been changed.

Optionally, the processing apparatus 501 is used for receiving, through the communication apparatus 503, a data change request coming from a first account and carrying second changed data, wherein the data change request is used for requesting to change data corresponding to the first account according to the second changed data, and the first account is any one of at least one blockchain account; detect the data type of the second changed data, determine a target information processing strategy corresponding to the data type according to a preset smart contract, and execute the target information processing strategy on the data change request.

Optionally, the smart contract comprises a change condition for changing data corresponding to the first account. The processing apparatus 501 is used for transmitting the data change request to associated accounts in a blockchain through the communication apparatus 503, wherein the associated accounts comprise at least one of the following: an account associated with the second changed data and an account associated with the first account; acquiring feedback information of the associated accounts for the data change request; and changing the data corresponding to the first account according to the second changed data if the feedback information meets the change condition.

Optionally, the processing apparatus 501 is used for transmitting the data change request to the centralized system through the communication apparatus 503, wherein the data change request is used for instructing the centralized system to send response information about successful verification after the centralized system successfully verifies the data change request; and receiving the response information, and changing the data corresponding to the first account according to the second changed data.

Optionally, the processing apparatus 501 is used for establishing a correspondence between predefined data types and information processing strategies, and generating the smart contract according to the correspondence.

Optionally, the processing apparatus 501 is used for determining the data type of the first changed data, and detecting whether the data type is bound with account information; or, determining whether account information exists in the first changed data.

Optionally, the processing apparatus 501 is used for parsing the feedback information, so as to determine the number of accounts allowing the data change request in the associated accounts, and determining that the feedback information meets the change condition if the number of accounts is greater than or equal to a preset number threshold value.

It should be noted that in the embodiments of the present invention, the specific implementation of the processing apparatus 501 can refer to the description of relevant content in the embodiments corresponding to the accompanying drawings.

Those of ordinary skill in the art can understand that implementation of all or a part of the processes in the method of the foregoing embodiment can be completed by a computer program that instructs relevant hardware. The program can be stored in a computer-readable storage medium. The program can include the processes of the embodiments of the foregoing methods when executed. The storage medium can be a magnetic disk, an optical disk, a read-only memory (ROM), or a random access memory (RAM), and the like.

What is disclosed above is only preferred embodiments of the present invention, and of course, is not used to limit the scope of the claims of the present invention. Therefore, equivalent changes made in accordance with the claims of the present invention still fall within the scope of the present invention.

1. A blockchain-based data management method, characterized by being applied to an information processing system, wherein the information processing system comprises a centralized system and a blockchain system, and the method comprises:
receiving, by the blockchain system, a first changed data transmitted by the centralized system, and updating the first changed data to all nodes included in the blockchain system;
detecting, by the blockchain system, whether an account information associated with the first changed data exists; and
sending, by the blockchain system, a prompt information to a target account corresponding to the account information if the blockchain system detects that the account information associated with the first changed data exists, wherein the prompt information is used for prompting that a data corresponding to the target account has been changed.

2. The method according to claim 1, characterized by further comprising:
receiving, by the blockchain system, a data change request coming from a first account and carrying a second changed data, wherein the data change request is used for requesting to change a data corresponding to the first account according to the second changed data, and the first account is any one of at least one blockchain account;
detecting, by the blockchain system, a data type of the second changed data; and
determining, by the blockchain system, a target information processing strategy corresponding to the data type according to a preset smart contract, and executing the target information processing strategy on the data change request.

3. The method according to claim 2, characterized in that the smart contract comprises a change condition for changing the data corresponding to the first account, and the step of executing, by the blockchain system, the target information processing strategy on the data change request comprises:
transmitting, by the blockchain system, the data change request to associated accounts, wherein the associated accounts comprise at least one of the following: an account associated with the second changed data and an account associated with the first account;
acquiring, by the blockchain system, a feedback information of the associated accounts for the data change request; and
changing the data corresponding to the first account according to the second changed data if the blockchain system determines that the feedback information meets the change condition.

4. The method according to claim 2, characterized in that the step of executing, by the blockchain system, the target information processing strategy on the data change request comprises:
transmitting, by the blockchain system, the data change request to the centralized system, wherein the data change request is used for instructing the centralized system to send a response information about successful verification after the centralized system successfully verifies the data change request; and
receiving, by the blockchain system, the response information, and changing the data corresponding to the first account according to the second changed data.

5. The method according to claim 2, characterized by further comprising:
establishing, by the blockchain system, a correspondence between predefined data types and information processing strategies; and
generating, by the blockchain system, the smart contract according to the correspondence.

6. The method according to claim 1, characterized in that the step of detecting, by the blockchain system, whether an account information associated with the first changed data exists comprises:
determining, by the blockchain system, a data type of the first changed data, and detecting whether the data type is bound with an account information; or,
determining, by the blockchain system, whether an account information exists in the first changed data.

7. The method according to claim 3, characterized in that after the step of acquiring, by the blockchain system, the feedback information of the associated accounts for the data change request, the method further comprises:
parsing, by the blockchain system, the feedback information, so as to determine a number of accounts allowing the data change request in the associated accounts; and
determining, by the blockchain system, that the feedback information meets the change condition if the number of accounts is greater than or equal to a preset number threshold value.

8. (canceled)

9. (canceled)

10. A computer-readable storage medium, characterized in that the computer-readable storage medium stores a computer program; the computer program comprises a program instruction; the program instruction, when executed by a processor, causes the processor to implement the method according to claim 1.

11. An information processing system, characterized by comprising:
a centralized system, used for transmitting a first changed data to a blockchain system; and
the blockchain system, used for receiving the first changed data transmitted by the centralized system, updating the first changed data to all nodes included in the blockchain system, sending a prompt information to a target account corresponding to an account information when detecting that the account information associated with the first changed data exists, wherein the prompt information is used for prompting that a data corresponding to the target account has been changed.

12. The method according to claim 3, characterized by further comprising:
establishing, by the blockchain system, a correspondence between predefined data types and information processing strategies; and
generating, by the blockchain system, the smart contract according to the correspondence.

13. The method according to claim 4, characterized by further comprising:
establishing, by the blockchain system, a correspondence between predefined data types and information processing strategies; and
generating, by the blockchain system, the smart contract according to the correspondence.
